(19) United States
(12) Patent Application Publication
(10) Pub. No.: US 2007/0208615 A1
(43) Pub. Date: Sep. 6, 2007

(54) Internet Based Sales System

(76) Inventor: Thomas F. Warner, Reston, VA (US)

Correspondence Address: GREENBERG & LIEBERMAN, LLC, 2141 WISCONSIN AVE, N.W., SUITE C-2, WASHINGTON, DC, 20007, US

(21) Appl. No.: 11/308,022

(22) Filed: Mar. 3, 2006

(51) Int. Cl. G06Q 30/00

(52) U.S. Cl. 705/14

(57) ABSTRACT

A method of selling products and services over the Internet for HVAC and other related devices and services. The customer is kept online as questions are asked so that an eventual work estimate and contract can be prepared electronically for the customer. The customer always has the option of contacting a person for help so that the customer does not feel as if s/he is being abandoned and left to answer questions online without assistance. The method takes the place of a live person having to actually visit, educate, and sell products to a customer in the customer's home.

### FIELD OF THE INVENTION

This present invention has to do with sales originating on the Internet. More particularly, the present invention focuses on HVAC, plumbing, electrical and other typical service repairs and installation contract work, and how such service repairs and installation contract work can be sold over the Internet.

### BACKGROUND OF THE INVENTION

There are many products that can be sold over the Internet. Some of the simplest products that can be sold over the Internet are books, magazines, music recordings and any typical product that you would see in a conventional store.

However, after you move from the realm of retail products, selling products requiring installation with a totally installed price over the Internet becomes difficult. One of the areas that is ripe for selling over the Internet is comfort services for repairs and installations of heating, cooling, plumbing and electrical equipment and appliances. Products such as emergency electrical generators, HVAC replacement equipment, plumbing devices, electrical devices, all usually are not chosen by the consumer on the Internet, or in a magazine, or even in a store; but for description and price of the installation or repair services, the consumer is typically used to a salesman or a representative from a company coming to their home, diagnosing the problem, seeing the particular requirements for installation and equipment that they have in the home, and then recommending a course of action wherein prices, timelines, various upgrades on equipment would be offered.

Thus, there is a need to enable the Internet to serve just as if you would have a representative from the company coming into the home, even though the representative's physical presence will not be in the home. Typically, if somebody wants the total installed price of generators, HVAC equipment, plumbing equipment, electrical equipment installed in their home, they would call a company that does such work. A salesman would actually come to the person's home. An estimate and sales presentation would be made and then the products and services would be sold at the contractor's disposal. While such a method of selling such products and services has worked, there is a clear need to use the Internet to improve contact between the business and the consumer. There is a need for a method that allows the consumer 24 hours a day, 7 days a week, to receive recommendations on products and services regarding HVAC, plumbing, electrical, electrical generator type services and products at the total installed price or pricing of services.

Further, there is a need to reach a generation that typically might not be used to the traditional sales model that is conditioned by society and by their age to look to the Internet and to trust the Internet as a point of sale, even for installed products or services that traditionally would not be sold in a store or on the Internet.

There is also a need to provide a large amount of information accessible by a computer that can educate a consumer about products to be installed in the home. While a technician, or representative of a company, might be able to, from experience, discuss various options for electrical, HVAC, et cetera, equipment in the home, it is nearly impossible for such a representative to keep himself updated daily on price changes, equipment changes, specials, recommendations, et cetera, without consulting some kind of manual or guidebook. Thus, there is a need for a point of sale for such products that will have such information, so that the consumer is empowered to literally browse on their computer and get all the information that they need to make a decision on a certain product and service at a particular price.

Moreover, if such products and services are to be ported over to some format that is accessible on the Internet, there is a need to make the information somewhat tailored to the individual consumer that is actually reviewing the material and looking to make a purchase. There is a need to have a format or an interface that will help the consumer, just as a representative would, as if that representative were standing in the consumer's home, to make choices and then ask questions based on certain choices, and gradually flesh out the full description and information necessary so that the consumer can understand what the costs will be, what the timeline will be and what products are recommended for what purposes.

All this needs to be done without the consumer having to click many different places and put together their own price list or browse many different sites, and put together their own information about a certain product. Essentially, the information has to be delivered intelligently.

### SUMMARY OF THE INVENTION

Harnessing the power of the Internet, the present invention provides a sales model for selling typical contractor product installation and services for equipment such as electrical generators, HVAC, plumbing and electrical equipment systems or products.

In short, the present invention asks certain questions of consumers. Once those questions have been answered, it then sends repair or installation contractors information about the consumers' desires and preferences. Customers can also request a diagnostic and/or repair visit or obtain the cost and order specific repairs that they know they need or want.

Lastly, consumers receive information within minutes, such information being in direct response to the information that the consumers provided. Consumers provide information such as what product and service they are interested in, the existing product system to be replaced, lifestyle and usage of residence, the general site conditions of the residence, special comfort concerns and the level of quality and price that is expected.

That information is then transmitted to the installation contractors. A draft contract for the equipment system or product to be installed is prepared, and the price of the work requested, meaning product price, as well as installation and service costs, are all included.

Within seconds, consumers receive the specific product and model number, or products and model numbers that meet their criteria. The consumers also receive information about the “installed” cost of the selected equipment or products. The consumer also receives information about the company to perform the repair or installation work, as well as the company's background in that particular type of equipment or product that has been chosen by the consumer to be installed.

### DETAILED DESCRIPTION OF THE PREFERRED EMBODIMENT

The first part of the present invention is to prequalify the customer. Basic questions are asked, such as the zip code of the customer; whether the customer owns the property; when the customer needs the new system installed; if the customer is at a residence or a business location; and whether the installation request is for new construction, for an addition, or for an existing residence.

The reason for the prequalification is to be sure that certain basic conditions are met, so that the present invention can actually work for not only the consumer, but also for the installer or service provider. The zip code of the customer is asked to ensure that geographically, the consumer can be served by the installer or service provider.

If, during the prequalification phase, the customer indicates that they do not legally own the property, the present invention will indicate that only the title holders of property can tender a proposal for upgrading an HVAC system or other related services and equipment on the premises. If somebody is leasing property, it is recommended by the present invention that the consumer have an owner initiate the process or directly contact a staff person.

The customer is asked when they would like the work to be done. This is important because it is necessary for the present invention to give quotes in the near future only. Industries such as the generator, HVAC, plumbing, electrical industries are subject to significant fluctuations in material supply and workload demand. It doesn't make sense for the present invention to provide a hedged quote that may not be truly representative of worth, and thus, to reflect the current market conditions and ensure that the present invention quotes highly competitive prices. It is necessary that the customer only use the present invention when work is requested to be done within a month window.

The customer is asked whether or not the installation and service will occur at a residence, light commercial, commercial or industrial venue. Commercial and industrial HVAC equipment, as well as generators, plumbing, electrical work, varies significantly from that installed in a residential or light commercial venue. Thus, to provide accurate pricing, the present invention needs to immediately know from the consumer which venue [residential, light commercial, commercial, or industrial] will be the site for the work.

The customer is asked whether or not the price quote is needed for an existing residence [or building], for new construction or an addition. If the consumer says that they need a price quote for new construction, then the present invention recognizes that there are certain unique challenges that are better served by certain firms that specialize only in that venue. If the customer indicates that the quote is necessary for an existing residence [or building] that has a new addition, the present invention will advise the customer that a review of architectural plans is most likely suggested, so that for HVAC systems a Manual “J” analysis for heating and cooling loads can be performed.

If the consumer indicates that the requested price quote is really just for an existing residence [or building] that is not going to be part of a new addition, and the price quote will not be for any new construction, then the customer is truly, completely qualified, and the present invention can move to Step Two.

Step Two of the prequalification asks what improvements are needed, for example, in the HVAC catagory such as HVAC Diagnostics and repair service, air conditioning replacement, heat pump system replacement, a duel-fuel heat pump and gas furnace upgrade, gas furnace replacement, or only indoor air quality improvements need to be made. There are unlimited product installations and services that can be offered, and this is the point at which those services are presented to the customer, so that the customer can narrow down for the present invention what is actually desired.

At this point, the present invention offers to display a sample contract, so that the customer can see what kinds of guarantees and representations are typically made by any installer that works via the present invention. This is important because building trust on the Internet requires up-front and full disclosure, and rather than continuing to ask questions of the customer, it is important to present the customer with a sample of what the customer will eventually be signing at the end.

Next, the present invention provides a general description of recommended products to go along with the consumer's preference. For example, if the consumer selected that they wanted an HVAC upgrade in their home, the present invention would recommend, just as a normal service contractor would if its contractor were physically in the person's home, that when one change is made in the home, it is easier to add other home air quality services. Information about the manufacturer of certain equipment that would accompany an HVAC upgrade or replacement is recommended and provided. Pricing is made available so that the customer can actually see, line by line, what different upgrades and additions to an HVAC system would cost. The customer can literally check off that they would like to add that option to the cost of an HVAC system. Any specials might also be noted at this time.

Next, the present invention needs to ascertain certain information about what the consumer already has. For example, the present invention will ask the manufacturer's name or brand and model number on equipment that is already in a home. Total cooling capacity or net and total BTU input and output will be requested.

It is recognized that a typical service person, or installation person, would actually be in the home to get this information, rather than requesting this information directly from the customer. Thus, the present invention has an option to upload a photo of an ID plate that would be on equipment. The uploaded photo can then be analyzed by the present invention, so that there is no burden on the consumer for using the present invention in place of a physical person actually in their home.

Lastly, recognizing that not everyone is comfortable providing information or taking digital pictures, the present invention offers the option of paying for an individual to come to the customer's home to literally look and gather the requested information on the existing equipment.

It is also important to note that at any time that the customer is using the present invention, the customer can always contact via email, Internet live chat, or otherwise, an individual so that they can actually talk to a person if they have problems using the present invention. This is not necessarily an opt-out of the present invention, so that the customer would take the traditional route of deciding to have an individual come to their home, and look at the actual equipment and provide an estimate and a timeline for installation of equipment, but rather, this is merely a way that somebody wanting to use the Internet, and feeling comfortable using the Internet, can continue to use the present invention while at the same time, having the ability to reach out and actually have live human help.

Next, the present invention requests information about the customer's lifestyle and usage of their residence, for example, if it is a residential installation. There are certain basic questions that are necessary, so that the lifestyle and usage of the residence, if it is a residential installation, will be appropriate with the equipment that is installed.

For example, the present invention inquires how many individuals typically reside at a residence, as well as whether there are frequent social gatherings, large groups are typically entertained, if there are rooms in the home that are closed off for prolonged periods, the typical temperature that is normally maintained during the winter heating season, the typical temperature that is normally maintained during the summer cooling season, the type of thermostat that the customer wants to control the temperature in the home, whether there are special usage rooms that need to maintain unique temperatures from the rest of the house, such as a nursery for a baby that might want to be kept warmer or cooler.

Next, the present invention inquires about the general site conditions of a residence. For example, the type of architectural unit is requested, such as, is it a single-family home, a townhouse, a condo, a mobile home, et cetera. The present invention also inquires about parking availability near the residence during normal business hours. Additional questions are how many square feet of floor space in the home is heated and cooled and whether there are any additions or crawlspaces, and the status of any possible construction that will occur in the near future.

The present invention also inquires as to whether or not there are multiple zones in the home for heating and cooling, and if so, is the system to be installed an upper or lower zone; whether or not the customer wants their HVAC unit, in this example, installed by an industry-certified manufacturer trained technician or not; where physically the existing indoor equipment to be replaced or serviced is located, such as a finished or unfinished basement, mechanical rooms on the first or second floor, an attic, a garage, et cetera. These questions are essentially for understanding how much time, and how difficult it will be, for the installer to reach and move the equipment.

Another typical question asked by the present invention is how best to describe access to an indoor central HVAC unit, for example, whether it is through a standard double-width exterior door at grade level or it is very limited access, if it is up multiple flights of stairs, et cetera. All this will affect the price that the present invention will quote, and all these things are items that normally would be recognized by a physical person in the residence inspecting the site where the installation will occur. Similar information as to the location and access of an outdoor HVAC unit of an air conditioning unit or heat pump is requested.

The present invention next turns to specific questions that will help determine the price quote for the customer. For example, it is important to understand what equipment needs to be matched with the expectations and needs of the customer, while at the same time, taking their financial resources into account.

One question asked by the present invention is why the customer is even seeking a price quote for an HVAC system, for example. Possible answers are that the customer was told that they should replace, rather than repair, an existing unit. Another answer might be that a neighbor's similar system had to be replaced because the unit stopped working and the customer thought it was an appropriate time to replace theirs as well before their unit stopped working.

Other answers could be that the customer has experienced frequent system breakdowns and so it has become very costly to continue to repair the system. High operating expenses for old systems might prompt people to want to get a new system. It could simply be that the system is not meeting the comfort needs of the customer.

All these answers are anticipated by the present invention and are provided as options. All these answers will factor into the recommendation that the present invention makes.

It is important for the present invention to ascertain the comfort level expectation and desires of the customer. Does the customer want the absolute best quality, premium quality, standard system quality or a low budget quality? Absolute quality would mean highest efficiency, temperature leveling throughout the home and the quietest noise level, for example. Premium quality might be a balance of a good temperature and control with excellent efficiency. A standard system might be good value, durable construction with great quality and performance, while a low budget system might be something that has the lowest initial investment, meets code requirements and code performance standards.

Special concerns that the customer might have are also very important to determining the price because if these concerns are present, the present invention will recommend a system that will solve the specific concern of the customer.

For example, conditions that might apply and might be of interest to a consumer would be that the entire residence is too hot or too cold during extreme weather conditions; that one or more rooms are too hot during extreme summer conditions or too cold during extreme winter conditions; that it takes too long to achieve a certain temperature during extreme conditions; that there is excessive noise coming from the equipment; that the actual equipment itself produces the noise or maybe the duct work or supply registers or return grills are actually the source of the noise. Maybe there is a certain odor that is present when the unit operates. Maybe the residence becomes too humid during summer months, even though a temperature is reached; maybe the residence is too dry in the winter months, even though there might be a humidifier present; and also reoccurring water damage from condensate, line blockage or pan floats, switch failure. Anything that might be objectionable by the customer should be noted to get an appropriate on-site quote that will solve any presently recognized problems.

Of course, contact information is important so that the user of the present invention is asked for their name, address, phone number, et cetera, typical contact information, so that a price quote can be returned to the customer and provided to the customer within seconds or so of the customer requesting a quote by using the present invention.

The last part of the present invention is to present the actual tailored contract based on the customer's responses to the queries of the present invention. The contract resembles a typical contract that would be presented by a live person who would be in the customer's home, and the option to print the contract is provided by the present invention as well.

For example, a sample contract would read that an existing air conditioner is to be removed and then new equipment is to be installed as follows at a certain residential address. It would provide the model number and other pertinent information regarding the air conditioning system. It would note whether or not a programmable thermostat would be installed, how long the warranty on parts and labor is and provide a price.

The customer could also be presented, in the same contract, with another system that would meet most of the customer's demands, and a price for that system would be provided as well. Any options that are not included in the quoted prices would be noted. The standard services that are to be performed, such as EPA standards for refrigerant recovery, record keeping and handling, and other code and standard equipment installation procedures would be listed.

The present invention would also provide on the contract important project notes typically provided on a standard contract that a person would provide a customer or client in person, for example, that the installation will take approximately one full day; final inspection will be scheduled for a day of the customer or client's choosing; that the installation is limited to the description and scope of services stated in the contract, et cetera.

An important difference between the present invention and the conventional service visit for purchasing HVAC and electrical equipment, plumbing and generators, is that the present invention will have in the contract that within one business day or so, a site visit will be made to verify site conditions and schedule the installation. This is important, if for no other reason, to ensure that everything represented in the information provided in the present invention by the customer is accurate and amenable to the installer.

The client or customer will then need to actually sign the printed contract. If conditions on the site do not correspond with the customer's information, then the company representative verifying the site conditions will amend the contract by listing the additional tasks, materials and pricing change before either party signs the contract. But barring unforeseen circumstances, the contract generated by the present invention will serve as the contract to be signed by the customer or client and the installer, such that work can begin and terminate.

The presentation of the present invention on the screen is a critical component to ensuring that the present invention is successful, not only in obtaining the appropriate information from the customer or client, but moreover, to ensure that the customer or client actually stays interested and does not feel as if they are filling out an online survey, or simply answering a lot of questions and getting nothing in return.

Thus, the present invention interface that the customer or client would see on their computer monitor is designed to have a Step One and Step Two indicated on the screen, such that the customer or client understands that there are two steps to an inquiry. For example, if information about the home is requested, all the questions are formatted to appear on two pages, and the customer or client will see a “1” highlighted or in color, indicating that they are on the first page, and then a “2” that is grayed out, so that the customer or client knows that the questions and inquiries will not continue forever, and that an actual end to the present invention will be that they will have a price quote.

This aspect of the present invention should not be understated because for the customer or client to actually feel that they have the attention and responsiveness that an individual in their home would provide, the interface of the present invention must at all times provide an instant way to contact via email, a person who can help the customer or client continue using the present invention.

The present invention is unique because it reduces the process to two steps, into simple formulations, and provides for an efficient online method that can be used for installing HVAC equipment, electrical needs, plumbing needs, and emergency generator needs. In short, the present invention is comprised of a pre-qualification phase, a recommendation, price quote and a contract. The present invention also solves the problem of a customer not willing to sign a contract without the expert having seen the site. Alternative embodiments can be designed for electrical, plumbing and generator needs.

The present invention should not be construed to be limited to the sole embodiments described above. The present invention should be understood to encompass any and all embodiments within the scope of the following claims.

What is claimed is:

1. A method of estimating and selling products and services over the Internet to a customer, comprising:
prequalifying a customer;
determining current products owned by the customer;
determining the current purchasing needs of the customer;
determining the lifestyle and usage needs of the customer;
determining the site conditions of the customer;
determining the system defects for the customer;
determining the quality level desired for the customer; and
recommending a product to the customer.

2. The method of claim 1 wherein said prequalifying a customer is asking basic questions, such as the zip code of the customer; whether the customer owns the property; when the customer needs a new system installed; if the customer is at a residence or a business location; and whether the installation request is for new construction, for an addition, or for an existing residence.

3. The method of claim 1 wherein said determining the site conditions of the customer's home comprises inquiring where the existing indoor equipment to be replaced or serviced is physically located.

4. The method of claim 1, further comprising determining what improvements are needed by gathering information about the from customer.

5. The method of claim 1, further comprising displaying a sample contract.

6. The method of claim 1, further comprising providing a general description of recommended products.

7. The method of claim 1, further comprising determining a price quote for the services.

8. The method of claim 1, further comprising finalizing a contract.

9. The method of claim 1 wherein the customer may communicate with a sales representative via email or chat at any time during the process.

10. The method of claim 1 wherein the interface of the Internet page inquiry used by the customer is comprised of a first step and a second step.

11. A method of estimating and selling products and/or services over the Internet to a customer, comprising:
asking a customer questions relating to a product or service to be purchased;
presenting a contract to the customer relating to a product or service to be purchased;
visiting a site prior to delivery of the product or service, once the contract has been signed by the customer.

12. The method of claim 10, wherein said visiting a site prior to delivery of the product or service serves to confirm that the customer provided correct answers to the questions that the customer answered relating to a product or service to be purchased.

13. The method of claim 10, wherein said visiting a site prior to delivery of the product or service occurs within one business day or so to verify site conditions and schedule the installation.
